(19) United States
(12) Patent Application Publication
(10) Pub. No.: US 2017/0044737 A1
(43) Pub. Date: Feb. 16, 2017

(54) RECOVERING ENERGY FROM HYDRAULIC SYSTEM OF A MACHINE

(71) Applicant: Caterpillar Inc., Peoria, IL (US)

(72) Inventor: Xinyu Ge, Peoria, IL (US)

(73) Assignee: CATERPILLAR INC., Peoria, IL (US)

(21) Appl. No.: 14/826,535

(22) Filed: Aug. 14, 2015

(51) Int. Cl. E02F 9/22; F15B 11/08; F15B 13/04; F15B 1/04

(52) U.S. Cl. CPC E02F 9/2217; F15B 1/04; F15B 11/08; F15B 13/0401; F15B 2201/00

(57) ABSTRACT

The present disclosure is related to an energy recovery system for a machine having an implement. The energy recovery system includes a linear actuator configured to move the implement and an accumulator configured to selectively collect pressurized fluid from the linear actuator. The energy recovery system includes a first control valve configured to regulate a capacity of the accumulator, a second control valve fluidly disposed between the accumulator and the linear actuator, and a controller. The controller is configured to determine a first level capacity of the accumulator based on a condition of a terrain traversable by the machine during a travel segment. The controller is configured to control the first control valve to set the capacity of the accumulator based on the determined first level capacity prior to the travel segment.

### TECHNICAL FIELD

The present disclosure relates to a hydraulic system of a machine, and more particularly relates to an energy recovery system and a method of recovering energy from the hydraulic system of the machine.

### BACKGROUND

Machines, such as wheel loaders and hydraulic excavators, typically include a vibration suppressing device to reduce vibrations. Reduction of vibrations may be necessary to minimize spillage of load. Such vibration suppressing devices generally include an accumulator in fluid communication with one or more cylinders in order to store vibration energy during travel of the machine. The accumulator needs to be fluidly isolated from the cylinders during various operations (such as, excavation) of the machine in order to maintain efficiency.

Conventionally, vibration suppressing devices are controlled based on vehicle speed. The accumulator is fluidly communicated with the cylinders when the machine travels above a threshold speed. However, there may be cases when the machine may perform operations at high speeds. The accumulator may remain in fluid communication with the cylinders, thereby reducing efficiency. Further, the machine may travel at speeds lower the threshold speed. In such a situation, the accumulator remains fluidly isolated. As a result, vibrations are not reduced and vibration energy is not recovered.

Further, in some cases, the accumulator may be at full capacity or close to full capacity. Therefore, the accumulator may be unable to reduce vibrations. In order to avoid this, multiple accumulators or an accumulator with large capacity may be required. However, increase in size or number may make packaging of the accumulator or accumulators difficult and increase costs of the vibration suppressing device.

U.S. Pat. No. 8,548,692 (the '692 patent) discloses a travel vibration suppressing device connected to a hydraulic cylinder for operating a work machine. The travel vibration suppressing device of the '692 patent utilizes an accumulator and a control valve for communication or blocking between the hydraulic cylinder and the accumulator. The travel vibration suppressing device further includes a vehicle speed detecting device to detect a speed of the work machine, a work machine state determination section to determine whether the state of the work machine is an excavating state or a normal state and a control unit for controlling the control valve according to the state of the work machine. Apart from the speed of the work machine, other operating parameters, such as the terrain condition and various operating segments of the work machine, such as travel segments, dump segments and lowering segments causes vibration to the work machine. Such operating parameters of the work machine and the various operating segments thereof may not be considered in the travel vibration suppressing device of the '692 patent.

### SUMMARY OF THE DISCLOSURE

In one aspect of the present disclosure, an energy recovery system for a machine having an implement is provided. The energy recovery system includes a linear actuator configured to move the implement and an accumulator configured to selectively collect pressurized fluid from the linear actuator. The energy recovery system also includes a first control valve configured to regulate a capacity of the accumulator and a second control valve fluidly disposed between the accumulator and the linear actuator. The second control valve is configured to regulate a flow of pressurized fluid between the linear actuator and the accumulator. The energy recovery system further includes a controller disposed in communication with the first control valve and the second control valve. The controller is configured to determine that a work cycle of the machine includes a travel segment. The controller is further configured to receive an input indicative of a condition of a terrain traversable by the machine during the travel segment. The controller is also configured to determine a first level capacity of the accumulator based on the condition of the terrain. The controller is further configured to control the first control valve to set the capacity of the accumulator based on the determined first level capacity prior to the travel segment. The controller is also configured to control the second control valve to allow flow of pressurized fluid from the linear actuator to the accumulator during the travel segment.

In another aspect of the present disclosure, a method of recovering energy in a machine having an implement is provided. The method includes determining that a work cycle of the machine includes a travel segment. The method further includes receiving an input indicative of a condition of a terrain traversable by the machine during the travel segment. The method also includes determining a first level capacity of an accumulator based on the condition of the terrain. The accumulator is configured to selectively collect pressurized fluid from a linear actuator associated with the implement. The method further includes setting the capacity of the accumulator based on the determined first level capacity prior to the travel segment. The method also includes allowing flow of pressurized fluid from the linear actuator to the accumulator during the travel segment.

In yet another aspect of the present disclosure, a machine is provided. The machine includes a frame, an implement movably coupled to the frame and an energy recovery system. The energy recovery system includes a linear actuator configured to move the implement and an accumulator configured to selectively collect pressurized fluid from the linear actuator. The energy recovery system also includes a first control valve configured to regulate a capacity of the accumulator and a second control valve fluidly disposed between the accumulator and the linear actuator. The second control valve is configured to regulate a flow of pressurized fluid between the linear actuator and the accumulator. The energy recovery system further includes a controller disposed in communication with the first control valve and the second control valve. The controller is configured to determine that a work cycle of the machine includes a travel segment. The controller is further configured to receive an input indicative of a condition of a terrain traversable by the machine during the travel segment. The controller is also configured to determine a first level capacity of the accumulator based on the condition of the terrain. The controller is further configured to control the first control valve to set the capacity of the accumulator based on the determined first level capacity prior to the travel segment. The controller is also configured to control the second control valve to allow flow of pressurized fluid from the linear actuator to the accumulator during the travel segment.

Other features and aspects of this disclosure will be apparent from the following description and the accompanying drawings.

### BRIEF DESCRIPTION OF THE DRAWINGS

FIG. 1 is a schematic top view of an exemplary worksite showing a machine operating therein;

FIG. 2 is a side view of a machine at a dig location, according to an embodiment of the present disclosure;

FIG. 3 is a side view of the machine at a dump location, according to an embodiment of the present disclosure;

FIG. 4 is a schematic view of an energy recovery system of the machine, according to an embodiment of the present disclosure;

FIG. 5 is a block diagram of a control system of the energy recovery system, according to an embodiment of the present disclosure; and

FIG. 6 is a flow chart of a method of recovering energy in the machine, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

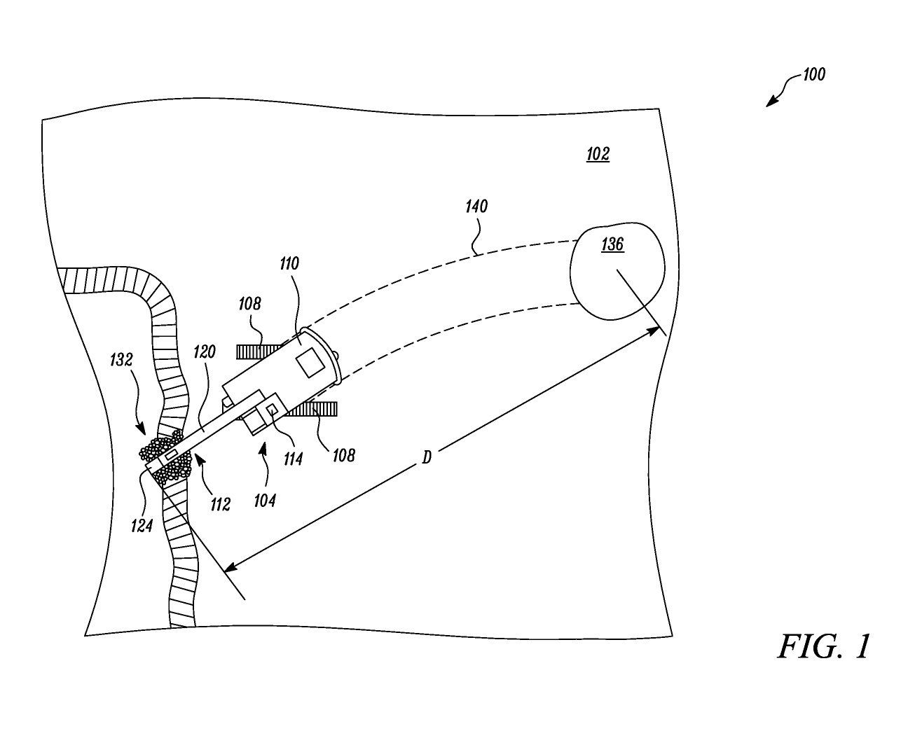

In an embodiment, FIG. 1 illustrates a schematic top view of a worksite 100 including a ground surface 102. The worksite 100 may be a portion of a mining site, a landfill, a quarry, a construction site, a road worksite, a forest, a farm, or any other area in which movement of material is desired. As shown in FIG. 1, a machine 104 is controlled to perform various earth moving operations in the worksite 100. In the illustrated embodiment, the machine 104 is a hydraulic excavator. However, the machine 104 may be any machine that performs work based on repetitive work cycles for the purpose of construction, mining, quarrying, and so on. For example, the machine 104 may be a wheel loader, an electric shovel, a dragline excavator, and the like. Further, the machine 104 may be controlled in an autonomous mode, a semi-autonomous mode, or a manual mode.

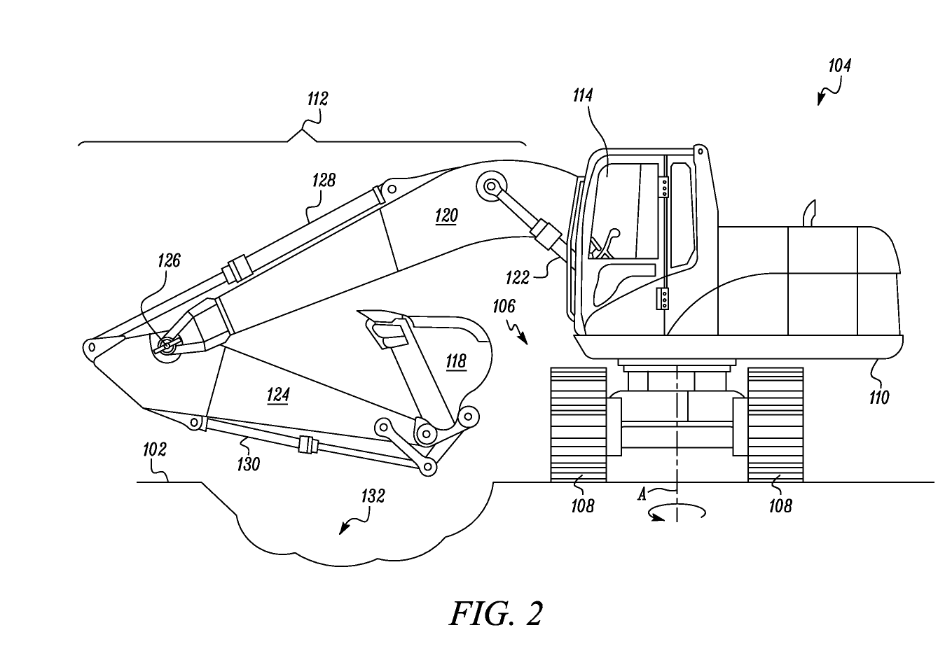

In an embodiment, FIG. 2 illustrates a side view of the machine 104. Referring to FIGS. 1 and 2, the machine 104 includes an undercarriage 106 for moving the machine 104 over the ground surface 102. The undercarriage 106 includes ground engaging members 108 for supporting the machine 104 and for engaging with the ground surface 102 in order to move the machine 104 along the ground surface 102. In the illustrated aspect of the present disclosure, the ground engaging members 108 are a pair of tracks. However, in other aspect of the current disclosure, the ground engaging members 108 may be multiple wheels. The machine 104 further includes a frame 110 rotatably disposed on the undercarriage 106. The frame 110 is rotatable about a vertical axis “A”. Further, the frame 110 may support various components of the machine 104 including an implement system 112 and an operator cab 114. The operator cab 114 may enclose various control members, such as one or more levers, joysticks, pedals, and the like, for controlling operations of the machine 104 in response to inputs from an operator.

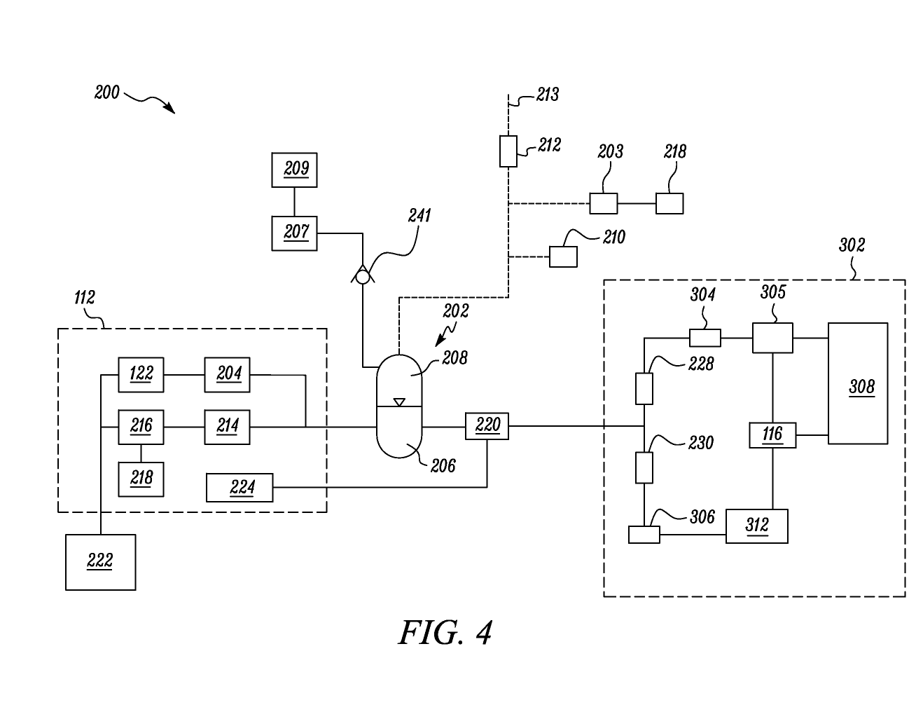

The machine 104 further includes an engine 116 (shown in FIG. 4) for providing power to the ground engaging members 108, the implement system 112 and various components of the machine 104. The engine 116 may be, for example, a diesel engine, a gasoline engine, a gaseous fuel engine, or any other type of combustion engine known in the art. However, in alternative embodiments, the machine 104 may be powered by an external power source, an onboard battery, and the like.

Further, the implement system 112 includes an implement 118 for performing various operations, such as digging, leveling, etc. The implement system 112 movably coupled the implement 118 to the frame 110. In the illustrated embodiment, the implement 118 is a bucket. However, in various alternative embodiments, the implement 118 may be a ripper, a drill, a scraping tool etc. The implement system 112 includes a boom member 120 pivotally connected to the frame 110. The boom member 120 is moved relative to the ground surface 102 using a first linear actuator 122. The first linear actuator 122 is coupled between the frame 110 and the boom member 120. The boom member 120 is further pivotally connected to a stick member 124 via a pin member 126. A second linear actuator 128 is coupled between the boom member 120 and the stick member 124 to move the stick member 124 relative to the boom member 120. The implement 118 is pivotally connected to the stick member 124. A third linear actuator 130 is coupled between the stick member 124 and the implement 118 to move the implement 118 relative to the stick member 124.

In the illustrated embodiment, the first, second and third linear actuators 122, 128, 130 are hydraulic cylinders. In other embodiments, each of the first second and third linear actuators 122, 128, 130 may be double acting hydraulic cylinders including a housing (not shown) and a piston (not shown) movably received within the housing. The piston is coupled to a rod (not shown) which extends through the housing and connected to the respective component (the boom member 120, the stick member 124 or the implement 118) of the implement system 112. The piston divides the housing into a head chamber distal to the rod and a rod chamber proximal to the rod. The head and rod chambers may be selectively supplied with pressurized fluid and drained of pressurized fluid to cause the piston to move within the housing and actuate the rod accordingly. The rod in turn actuates the respective component of the implement system 112. Though a double acting cylinder is described above, one or more of the first second and third linear actuators 122, 128, 130 may also be single acting cylinders within the scope of the present disclosure.

The machine 104 further includes a hydraulic system (not shown) powered by the engine 116. The hydraulic system may supply pressurized fluid to the implement system 112 and various other systems, such as a steering system and a brake system of the machine 104.

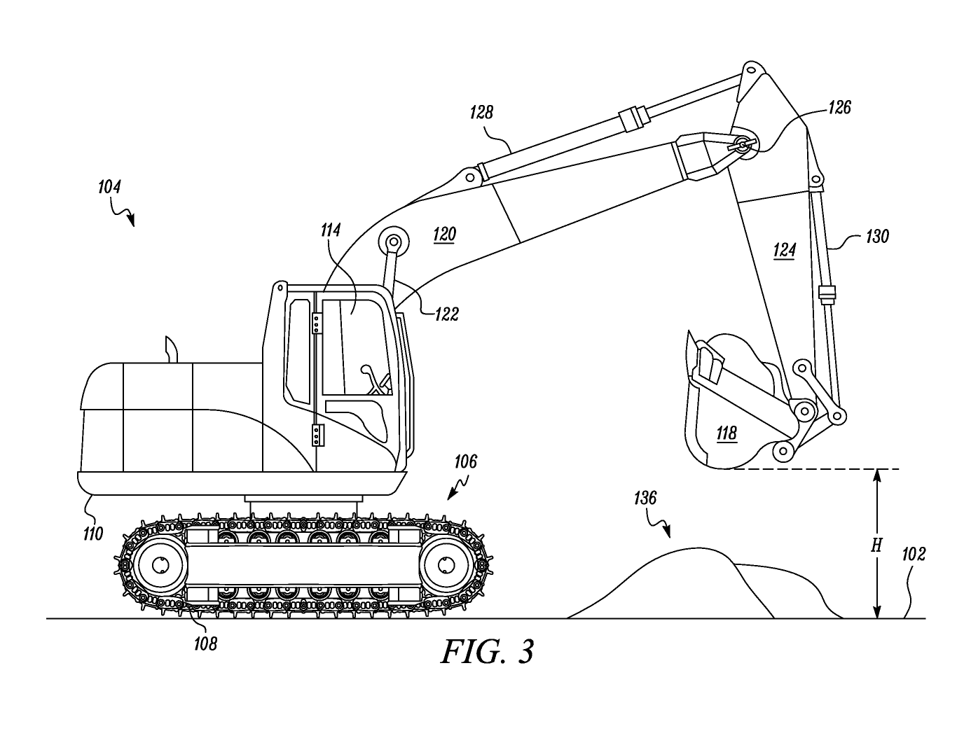

In an embodiment, FIG. 3 illustrates a side view of the machine 104 at a dump location 136 in the worksite 100. An exemplary work cycle of the machine 104 is described below with reference to FIGS. 1 to 3. The work cycle of the machine 104 may be divided into a dig segment, a lift segment, a first swing segment, a first travel segment, a lowering or dump segment, a second travel segment, a second swing segment, and another dig segment. However, in other embodiments, the work cycle of the machine 104 may include additional segments, for example, a move up a steep grade segment and a move down a steep grade segment. Such a work cycle of the machine 104 may be repeated to perform various works, such as an earth moving operation. The above segments are provided merely as examples for the purpose of the present disclosure.

In an example, the machine 104 may start with a dig segment at a dig location 132. In the dig segment, the boom member 120, the stick member 124 and the implement 118 may be actuated by the first, second and third linear actuators 122, 128, 130, respectively, to dig the ground surface 102 at the dig location 132. The implement 118 may be partially or fully filled with material, such as soil. Furthermore, in the lift segment, the boom member 120, the stick member 124 and the implement 118 may be moved to lift the material contained in the implement 118. In an example, the machine 104 may have to dump the material at the dump location 136. The implement 118 may be lifted to locate the implement 118 at a suitable height above the ground surface 102. Specifically, the implement 118 may be located at a height “H” (shown in FIG. 3) above the ground surface 102 at the dump location 136. In the illustrated embodiment, the dump location 136 may be separated from the dig location 132 by a distance “D” (shown in FIG. 1). In the first swing segment, the frame 110 of the machine 104 may swing about the vertical axis “A” such that the implement system 112 faces the dump location 136.

During the first travel segment, the machine 104 may traverse a terrain 140 between the dig location 132 and the dump location 136 such that the implement system 112 is located above the ground surface 102 at the dump location 136. Further, in the lowering or dump segment, the material contained in the implement 118 may be dumped in the dump location 136 by lowering and tilting the implement 118. Though in the illustrated embodiment, the machine 104 is dumping the material directly on the ground surface 102, it may be contemplated that the machine 104 may also dump the material in a payload carrier (not shown) of a truck (not shown).

Subsequently, in the second travel segment, the machine 104 may traverse the terrain 140 to move back to the dig location 132. Further, in the second swing segment, the frame 110 is rotated about the vertical axis “A” such that the implement system 112 faces the dig location 132. A subsequent dig segment may be then initiated. Thus, the work cycle including the above segments is repeated to continue the earth moving operation.

During the first and second travel segments, various components of the machine 104 including the implement system 112 may undergo vibrations based on a roughness of the terrain 140 traversed by the machine 104. Such vibrations may result in spillage in the material from the implement 118. In order to minimize spillage, an energy recovery system 200 (shown in FIG. 4) is provided to suppress the vibrations of the implement system 112 and at least partially store an energy associated with the vibrations. The energy recovery system 200 will be described in detail hereinafter.

In an embodiment, FIG. 4 illustrates a schematic view of the energy recovery system 200 of the machine 104. Referring to FIGS. 1 to 4, the energy recovery system 200 includes an accumulator 202, a first control valve 203 configured to regulate a capacity of the accumulator 202, and a second control valve 204 fluidly disposed between the accumulator 202 and the first linear actuator 122.

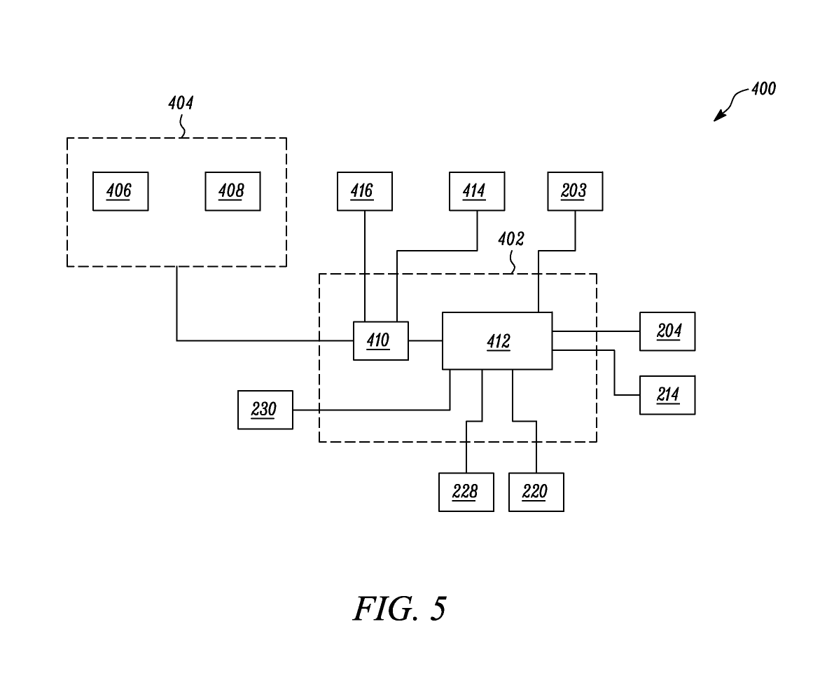

The accumulator 202 may be a variable capacity accumulator including a first chamber 206 configured to selectively collect pressurized fluid from the first linear actuator 122 and a second chamber 208 configured to receive gaseous fluid therein. The first chamber 206 of the accumulator 202 may be fluidly coupled to the head chamber of the first linear actuator 122. The first and second chambers 206, 208 may be separated by a movable piston (not shown). Gaseous fluid may be air or an inert gas (for example, nitrogen). A pressure of the gaseous fluid within the second chamber 208 may be varied to regulate the capacity of the accumulator 202. It may be apparent to a person of ordinary skill in the art that the pressure of the gaseous fluid is inversely proportional to the capacity of the accumulator 202. In the illustrated embodiment, the first control valve 203 may be regulated by a controller 402 (shown in FIG. 5) to vary the pressure of gaseous fluid within the second chamber 208. Further, a pressure sensor 210 may be provided between the first control valve 203 and the second chamber 208 to detect the pressure within the second chamber 208. The controller 402 may be communicably disposed with the pressure sensor 210 to determine the pressure within the second chamber 208 and control the first control valve 203 accordingly. In an example, the first control valve 203 may be an electrically controlled proportional relief valve. In an example, the controller 402 may regulate the capacity of the accumulator 202 as a fraction or percentage of a maximum capacity “Cmax” of the accumulator 202.

The energy recovery system 200 may further include a manual valve 212 configured to regulate the capacity of the accumulator 202 based on a user input. In an example, the manual valve 212 may be a needle control valve disposed in communication with a manual vent line 213. The manual valve 212 may be directly or indirectly controlled by the operator. The manual vent line 213 may also be used for servicing and/or maintenance of the machine 104.

The second chamber 208 of the accumulator 202 is fluidly coupled to a source device 209 for receiving the gaseous fluid, such as the air. A directional valve 207 is fluidly disposed between the second chamber 208 of the accumulator 202 and the source device 209 to selectively allow the gaseous fluid to flow to the second chamber 208 from the source device 209. Further, a check valve 241 is fluidly disposed between the directional valve 207 and the accumulator 202 to allow a unidirectional flow of the gaseous fluid between the accumulator 202 and the source device 209. In one example, the source device 209 may be an outlet of a compressor associated with a turbocharger of the engine 116. In another example, the source device 209 may be a tank containing compressed air. In yet another example, the source device 209 may be any other external device supplying the gaseous fluid.

The gaseous fluid may be introduced into the accumulator 202 when a level of the pressurized fluid in the first chamber 206 is adjacent to a bottom thereof or the pressurized fluid is almost depleted, and hence, a pressure within the second chamber 208 is lower than a supply pressure of the gaseous fluid. The check valve 241 may ensure a direction of flow of the gaseous fluid from the source device 209 to the second chamber 208 of the accumulator 202. Thus a volume of the gaseous fluid flowing into the second chamber 208 of the accumulator 202 may be varied by controlling the directional valve 207. The directional valve 207 may be communicated with the controller 402. The thermodynamic process of the gaseous fluid within the second chamber 208 may vary due to different parameters of the gaseous fluid, such as a pressure and a temperature at which the gaseous fluid is received within the second chamber 208.

Further, the second control valve 204 is configured to control a flow of pressurized fluid between the first linear actuator 122 and the accumulator 202. Specifically, the second control valve 204 may regulate the flow of pressurized fluid between the head chamber of the first linear actuator 122 and the first chamber 206 of the accumulator 202. The energy recovery system 200 also includes a fourth control valve 214 disposed between the accumulator 202 and a swing circuit 216 of the machine 104. The swing circuit 216 fluidly connects to a swing motor 218 which is configured to selectively rotate the frame 110 of the machine 104 about the vertical axis “A” (shown in FIG. 2). In the illustrated embodiment, the swing circuit 216 may be part of the implement system 112 of the machine 104. Further, the fourth control valve 214 is configured to regulate flow of pressurized fluid between the accumulator 202 and the swing motor 218. The second and fourth control valves 204, 214 may be disposed in communication with the controller 402. Further, the second and fourth control valves 204, 214 may be electrically controlled proportional valves.

Though the energy recovery system 200 is associated with the first linear actuator 122, it may be contemplated that the energy recovery system 200 may include additional valves (not shown) for regulating flow between the accumulator 202, and the second and/or third linear actuators 128, 130.

The energy recovery system 200 also includes a third control valve 220 fluidly disposed between the accumulator 202 and a powertrain 302 of the machine 104. Further, the third control valve 220 is configured to regulate a flow of the pressurized fluid between the accumulator 202 and the powertrain 302. In an example, the third control valve 220 may be a three-way three-position valve or a combinations of two-way two-position valves fluidly coupled with the powertrain 302, the implement system 112 and the accumulator 202. Further, the third control valve 220 may be communicably coupled to and electrically controlled by the controller 402. In the illustrated embodiment, the third control valve 220 is connected to implement control circuits 224 of the implement system 112. The implement control circuits 224 may supply pressurized fluid to various components of the implement system 112 including the first, second and third linear actuators 122, 128, 130, and the swing circuit 216. The energy recovery system 200 further includes a reservoir 222 fluidly communicated with the first linear actuator 122 and the swing circuit 216. The reservoir 222 configured to store and supply fluid at low pressure to various components of the machine 104 including the first linear actuator 122 and the swing circuit 216.

The third control valve 220 may further have three configurations. In a first configuration, the third control valve 220 may allow fluid communication between the accumulator 202 and the implement control circuits 224, and block fluid communication between the accumulator 202 and the powertrain 302. In a second configuration, the third control valve 220 may allow fluid communication between the accumulator 202 and the powertrain 302, and block fluid communication between the accumulator 202 and the implement control circuits 224. In a third configuration, the third control valve 220 may block fluid communication between the accumulator 202 and both the powertrain 302 and the implement control circuits 224. Further, the third control valve 220 may be a proportional valve configured to adjust a flow rate of pressurized fluid from the accumulator 202 to both the implement control circuits 224 and the powertrain 302.

The powertrain 302 includes the engine 116, a first hydraulic actuator 304, a variable speed actuator 305, a second hydraulic actuator 306 and a final drive 308. The variable speed actuator 305 may be drivably coupled to the engine 116 for driving the ground engaging members 108 at various speeds and torques. Further, the engine 116 and the variable speed actuator 305 are drivably coupled to the final drive 308. The final drive 308 may be further drivably coupled to the ground engaging members 108 of the machine 104.

In an example, the variable speed actuator 305 may be a hydrostatic continuously variable transmission (CVT) including a hydraulic pump (not shown) and a hydraulic motor (not shown) drivably coupled to the hydraulic pump. The hydraulic motor provides an output power to the final drive 308. The hydraulic pump may receive fluid from the hydraulic system associated with the machine 104. Further, the hydraulic pump may be driven by the engine 116. The hydraulic pump further includes a swash plate actuated by the first hydraulic actuator 304. The first hydraulic actuator 304 may be a hydraulic cylinder configured to adjust an angle of the swash plate. Further, the hydraulic cylinder may be controlled by the controller 402. An output speed and torque of the variable speed actuator 305 may be regulated by the angle of the swash plate.

The second hydraulic actuator 306 may be a hydraulic motor configured to provide power to a cooling system 312 associated with the powertrain 302 including the engine 116. The cooling system 312 may include a coolant pump and/or a cooling fan.

The energy recovery system 200 further includes a first powertrain valve 228 and a second powertrain valve 230. In an example, each of the first and second powertrain valves 228, 230 may be an electrically controlled proportional valve. The controller 402 is also communicably coupled with the first and second powertrain valves 228, 230. The first powertrain valve 228 is fluidly disposed between the third control valve 220 and the first hydraulic actuator 304. The controller 402 regulates the first powertrain valve 228 to selectively allow fluid communication between the third control valve 220 and the first hydraulic actuator 304 in order to adjust the angle of the swash plate. The second powertrain valve 230 is fluidly disposed between the third control valve 220 and the second hydraulic actuator 306. Further, the controller 402 regulates the first powertrain valve 228 to selectively allow fluid communication between the third control valve 220 and the second hydraulic actuator 306 in order to provide power to the cooling system 312.

In an embodiment, FIG. 5 illustrates a control system 400 of the energy recovery system 200. Referring to FIGS. 1 to 5, the control system 400 includes the controller 402 and a load sensing module 404 disposed in communication with the controller 402. The load sensing module 404 includes at least one grade sensor 406 configured to generate signals indicative of a position of the machine 104 relative to the ground surface 102. In an example, the load sensing module 404 may include a first grade sensor disposed along a front drive axis of the machine 104 and a second grade sensor disposed along a rear drive axis of the machine 104. The first and the second grade sensors together may be configured to generate signals indicative of the position of the machine 104 relative to the ground surface 102. Specifically, the signals generated by the first and the second grade sensors may be compared to check whether the machine 104 is moving up or moving down relative to the ground surface 102. The load sensing module 404 further includes at least one load sensor 408 configured to generate signals indicative of a load carried by the machine 104 during various segments of the work cycle. For example, in the lift segment, the load sensor 408 may be configured to generate signals indicative of the amount of material contained in the implement 118.

The controller 402 may be an electronic controller that operates in a logical fashion to perform operations, execute algorithms, store and retrieve data and other desired operations. The controller 402 may embody a single microprocessor or multiple microprocessors configured to receive signals from the various sensors. Numerous commercially available microprocessors may be configured to perform the functions of the controller 402. A person of ordinary skill in the art will appreciate that the controller 402 may additionally include other components and may also perform other functions not described herein.

In the illustrated embodiment, the controller 402 includes a pattern recognition module 410 and a valve control module 412 disposed in communication with the pattern recognition module 410. The pattern recognition module 410 is configured to be in communication with multiple sensors to receive signals indicative of multiple operating parameters of the machine 104. The pattern recognition module 410 receives the signals generated by the grade sensor 406 and the load sensor 408 to determine a load acting on the machine 104. In an example, based on various parameters including, but not limited to, moving direction in a steep grade of the ground surface 102 and gross weight of the machine 104, the load acting on the machine 104 may be calculated.

The pattern recognition module 410 is further configured to be in communication with various sensors (collectively referred to as operation sensors 414). The operation sensors 414 may detect various parameters related to the powertrain 302 and the hydraulic system of the machine 104. The operation sensors 414 may include an engine speed sensor configured to generate signals indicative of a speed of the engine 116. The operation sensors 414 may also include at least one transmission sensor configured to generate signals indicative of the output speed of the variable speed actuator 305. The transmission sensor may also be associated with various other operating parameters of the variable speed actuator 305 including, but not limited to, a displacement and/or speed of the hydraulic pump, a position of the swash plate, a pressure of fluid flow, a speed of the hydraulic motor, and the like. Thus, the pattern recognition module 410 is configured to determine the load acting on the machine 104 and a current working cycle of the machine 104 based on the signals received from the grade sensor 406, the load sensor 408, and the operation sensors 414. Further, the controller 402 may also determine the height “H” of the implement 118 relative to the ground surface 102 based on the signals from the multiple sensors.

The control system 400 further includes a data storage module 416 configured to be in communication with the pattern recognition module 410. In an example, the data storage module 416 may include a non-transitory machine readable medium. The data storage module 416 may be configured to store multiple predefined working patterns of the machine 104. In various examples, the predefined working patterns may be defined based on historical data of various machine operating patterns. The machine operating patterns may determined based on real time field data or experimental data. In another embodiment, the predefined working patterns may be stored in the pattern recognition module 410.

The valve control module 412 is communicably coupled to the first, second, third and fourth control valves 203, 204, 220, 214, and the first and second powertrain valves 228, 230. Further, the controller 402 is configured to regulate the various valves of the energy recovery system 200 via the valve control module 412 based at least on signals received from the pattern recognition module 410.

An exemplary operation of the energy recovery system 200 will be now described with reference to FIGS. 1 to 5. The pattern recognition module 410 may receive signals from the various sensors and compare the operating parameters of the machine 104 with the predefined working patterns stored in the data storage module 416. The pattern recognition module 410 may determine the operating parameters over multiple iterations (for example, three iterations), and determine the current work cycle based on the comparison between the operating parameters and the predefined working patterns. Based on the comparison, the controller 402 may determine that the current work cycle includes one or more travel segments. In case the current work cycle is devoid of a travel segment, the controller 402 may actuate the second control valve 204 to block fluid communication between the first linear actuator 122 and the accumulator 202 as vibration reduction during travel is not required.

Further, the pattern recognition module 410 may continue to determine the operating parameters of the machine 104 based on signals from the sensors, and compare the current operating parameters with a predefined segment of the current work cycle. However, in certain situations, the current operating parameters may not completely match with the predefined segment. In such cases, the pattern recognition module 410 may determine a probability of the current operating parameters matching with the predefined segment. In case the determined probability is below a threshold (for example, 50%), the pattern recognition module 410 may determine that the current operating parameters do not match with the predefined segment, the controller 402 may regulate the various valves, including the first control valve 203 of the energy recovery system 200 based on a speed parameter of the machine 104. The speed parameter may be a filtered machine speed, such as, average machine speed over a predetermined duration (for example, 5 minutes).

However, in an example, the pattern recognition module 410 may determine the current work cycle as including the dig segment, the lift segment, the first swing segment, the first travel segment, the lowering or dump segment, the second travel segment, the second swing segment, and another dig segment. Further, the controller 402 may determine that the probability of the current operating parameters matching with the predefined segment of the current work cycle is equal to or greater than the threshold. Upon determination that that the current work cycle includes two travel segments, the controller 402 may receive an input indicative of a condition of the terrain 140 traversable by the machine 104 during the first and second travel segments. The condition of the terrain 140 corresponds to a degree of roughness. The input may have multiple discrete levels corresponding to the degree of roughness of the terrain 140. In an example, the discrete levels of the input may include extremely rough, rough, uneven and smooth.

The input may be obtained from the operator of the machine 104. The operator may provide the input based on visual inspection and/or experience of the terrain 140 traversed during one or more iterations of the work cycle. Further, the operator may provide the input via a user interface (not shown) disposed in communication with the controller 402. The user interface may include a switch, a lever, a keyboard, a touchscreen, a joystick, and the like. In an alternative embodiment, the controller 402 may automatically determine the input indicative of the condition of the terrain 140 based on vibrations experienced by the machine 104 during one or more iterations of the current work cycle.

The controller 402 may then determine a first level capacity “C1” of the accumulator 202 based on the condition of the terrain 140. The first level capacity “C1” may be a percentage of the maximum capacity “Cmax” of the accumulator 202. In an example, the first level capacity “C1” may be 90%, 60%, 50% and 20% of the maximum capacity “Cmax” for extremely rough, rough, uneven and smooth conditions, respectively. The controller 402 may further control the first control valve 203 to set the capacity of the accumulator 202 based on the determined first level capacity “C1” prior to the first and second travel segments. In an example, the controller 402 may determine a current capacity of the accumulator 202. The current capacity of the accumulator 202 may be above or below the first level capacity “C1”. Thus, the capacity of the accumulator is controlled based on the current capacity to match with the first level capacity “C1”. In an example, the accumulator 202 may set the capacity at the first level capacity “C1” just before the start of the first and second travel segments. In another embodiment, the controller 402 may set the capacity of the accumulator 202 at a default first level capacity “Cd” upon determining that the current work cycle includes one or more travel segments. The default first level capacity “Cd” may also be set prior to the first and second travel segments. In an example, the default first level capacity “Cd” may be 50% of the maximum capacity “Cmax” corresponding to uneven condition of the terrain 140. In a further embodiment, the operator may manually cause venting via the manual valve 212 before the start of the first or travel segments.

Further, the controller 402 may control the second control valve 204 to allow flow of pressurized fluid from the first linear actuator 122 to the accumulator 202 during the first and second travel segments. During the first and second travel segments, the boom member 120 may vibrate. These vibrations may be transferred to the rod and the piston of the first linear actuator 122. Due to movement of the piston, pressurized fluid from the head chamber may flow through the second control valve 204 to the first chamber 206 of the accumulator 202. The controller 402 may also regulate the fourth control valve 214 to block fluid communication between the accumulator 202, and the swing circuit 216 during the first and second travel segments. Further, the controller 402 may control the third control valve 220 to selectively allow flow of pressurized fluid from the accumulator 202 to the powertrain 302 during the first and second travel segments. The energy stored in the accumulator 202 prior to the travel segments may be utilized to provide power to the first hydraulic actuator 304 and/or the second hydraulic actuator 306 during the travel segments. The controller 402 may regulate the first and second powertrain valves 228, 230 to control flow of pressurized fluid, and hence the power supplied to the first hydraulic actuator 304 and the second hydraulic actuator 306. The utilization of stored energy may further increase the capacity of the accumulator 202 enabling increased storage of vibration energy during the travel segments.

The controller 402 may also determine that the current work cycle includes the first and second swing segments. The controller 402 may control the second control valve 204 to block fluid communication between the first linear actuator 122 and the accumulator 202 after completion of the first and second travel segments. Further, during the first and second swing segments, the controller 402 may control the fourth control valve 214 to allow fluid communication between the accumulator 202 and the swing circuit 216. Pressurized fluid stored in the accumulator 202 may supply power to the swing motor 218 at a beginning of each of the first and second swing segments. Further, the accumulator 202 may store energy at an end of each of the first and second swing segments. Hence, the accumulator 202 may not require additional capacity as energy is both released and stored during the swing segments.

The controller 402 may further determine that the current work cycle of the machine 104 includes the lowering segment following the first travel segment. The controller 402 may further determine a parameter indicative of a payload of the implement 118. In an embodiment, the parameter may be a weight of the payload carried by the implement 118 at the dump location 136. The controller 402 may determine the weight of the payload based on signals received from the load sensor 408. The controller 402 may further determine the height “H” of the implement 118 relative to the ground surface 102 at the dump location 136. The controller 402 may then determine a second level capacity “C2” of the accumulator 202 based on the payload and the height “H”.

In an example, the second level capacity “C2” may depend on a gravitational potential energy “PE” of the payload. The gravitational potential energy “PE” may be determined based on the following equation:

PE=W*g*H

wherein:
“W” is the weight of the payload carried by the implement 118
“H” is the height of the implement 118 relative to the ground surface 102 at the dump location 136
“g” is acceleration due to gravity

The gravitational potential energy “PE” may be the maximum energy that may be recovered during the lowering segment by the accumulator 202. Hence, the second level capacity “C2”, which corresponds to the gravitational potential energy “PE”, may ensure maximum recovery of energy. The controller 402 may further determine if the current capacity of the accumulator 202 is less than the second level capacity “C2”. If the current capacity is less than the second level capacity “C2”, the controller 402 may control the first control valve 203 to set the capacity of the accumulator 202 at the second level capacity “C2” prior to the lowering segment. Further, the controller 402 may control the second control valve 204 to allow flow of pressurized fluid from the first linear actuator 122 to the accumulator 202 during the lowering segment. The controller 402 may also regulate the fourth control valve 214 to block fluid communication between the accumulator 202, and the swing circuit 216 during the lowering segment. The energy stored in the accumulator 202 during the lowering segment may be released during subsequent swing and/or lift segments. Further, the controller 402 may set the capacity of the accumulator 202 at the first level capacity “C1” before the subsequent travel segment.

### INDUSTRIAL APPLICABILITY

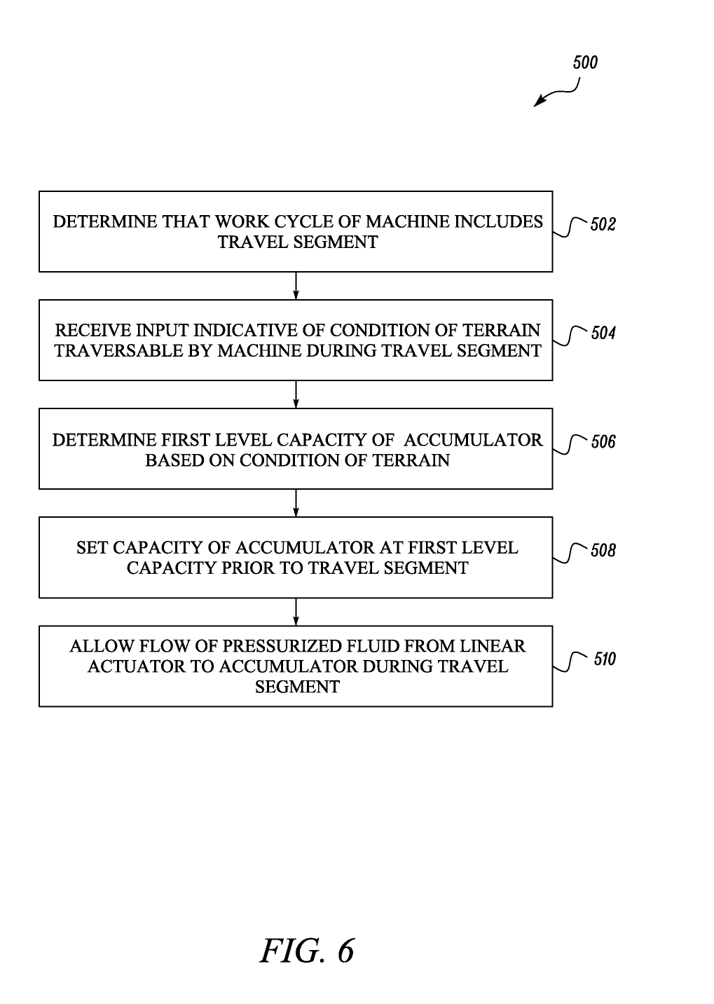

The present disclosure relates to the energy recovery system 200 and a method 500 for recovering energy. In an embodiment, FIG. 6 illustrates a flow chart of the method 500 of recovering energy in the machine 104. At step 502, the method 500 includes determining that the work cycle of the machine 104 includes one or more travel segments. At step 504, the method 500 includes receiving the input indicative of the condition of the terrain 140 traversable by the machine 104 during the travel segments. The method 500 also includes setting the capacity of the accumulator 202 at the default first level capacity “Cd” upon determining that the work cycle includes the travel segments. At step 506, the method 500 includes determining the first level capacity “C1” of the accumulator 202 based on the condition of the terrain 140. In one embodiment, the method 500 may include determining if the current capacity of the accumulator 202 is less than the first level capacity “C1”. In another embodiment, the method 500 may include determining if the current capacity of the accumulator 202 is more than the first level capacity “C1”. At step 508, the method 500 includes setting the capacity of the accumulator 202 based on the determined first level capacity “C1” prior to the travel segment. The method 500 may include controlling the first control valve 203 to set the capacity of the accumulator 202 based on the determined first level capacity. In the illustrated embodiment, the capacity of the accumulator 202 is set equal to the first level capacity “C1”. At step 510, the method 500 includes allowing flow of pressurized fluid from the first linear actuator 122 to the accumulator 202 during the travel segment. The method 500 also includes selectively allowing flow of pressurized fluid from the accumulator 202 to the powertrain 302 during the travel segments. The method 500 further includes blocking fluid communication between the accumulator 202 and the swing circuit 216 during the travel segments.

The method 500 also includes determining that the work cycle of the machine 104 includes the lowering segment. The method 500 includes determining the parameter indicative of the payload of the implement 118. The method 500 includes determining the height “H” of the implement 118 relative to the ground surface 102. The method 500 includes determining the second level capacity “C2” of the accumulator 202 based on the determined parameter and the height “H”. The method 500 includes determining if the current capacity of the accumulator 202 is less than the second level capacity “C2”. The method 500 includes setting the capacity of the accumulator 202 at the second level capacity “C2” prior to the lowering segment. The method 500 includes allowing flow of pressurized fluid from the first linear actuator 122 to the accumulator 202 during the lowering segment.

The energy recovery system 200 and the method 500 may enable vibration reduction and storage of vibration energy, swing energy and gravitational potential energy of the implement system 112 using a single accumulator. Hence, the energy recovery system 200 has a compact configuration and is cost effective. Further, control of the capacity of the accumulator 202 is based on the work cycle of the machine 104. Therefore, the capacity of the accumulator 202 is optimally changed prior to the travel and lowering segments such that energy recovery is maximized. The various valves of the energy recovery system 200 are also controlled based on the work cycle. Therefore, the accumulator 202 is also fluidly communicated with the appropriate components irrespective of the speed of the machine 104, thereby maintaining efficiency of the machine 104 during various operations, and recovering energy during travel and lowering segments.

By allowing both exhaust of the compressed air in the second chamber 208 of the accumulator 202 to an application 218 via the first control valve 203 and intake of the air from the source device 209 via the directional valve 207 and the check valve 241, the different parameters of the gaseous fluid in the second chamber 208 of the accumulator 202 can be adjusted. The application 218 may be an air assisted Selective Catalytic Reduction (SCR) system or a purging system for aftertreatment of exhaust gas of the engine 116. Thus an open type communication of the accumulator 202 may ensure vibration suppression function that is critical for delicate tasks, such as the travel segment.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An energy recovery system for a machine having an implement, the energy recovery system comprising:
a linear actuator configured to move the implement;
an accumulator configured to selectively collect pressurized fluid from the linear actuator;
a first control valve configured to regulate a capacity of the accumulator;
a second control valve fluidly disposed between the accumulator and the linear actuator, the second control valve configured to regulate a flow of pressurized fluid between the linear actuator and the accumulator; and
a controller disposed in communication with the first control valve and the second control valve, the controller configured to:
determine that a work cycle of the machine includes a travel segment;
receive an input indicative of a condition of a terrain traversable by the machine during the travel segment;
determine a first level capacity of the accumulator based on the condition of the terrain;
control the first control valve to set the capacity of the accumulator based on the determined first level capacity prior to the travel segment; and
control the second control valve to allow flow of pressurized fluid from the linear actuator to the accumulator during the travel segment.

2. The energy recovery system of claim 1, further comprising a third control valve fluidly disposed between the accumulator and a powertrain of the machine, the third control valve configured to regulate a flow of pressurized fluid between the accumulator and the powertrain.

3. The energy recovery system of claim 2, wherein the controller is further configured to control the third control valve to selectively allow flow of pressurized fluid from the accumulator to the powertrain during the travel segment.

4. The energy recovery system of claim 1, further comprising a manual valve configured to regulate the capacity of the accumulator based on a user input.

5. The energy recovery system of claim 1, wherein the controller is further configured to set the capacity of the accumulator at a default first level capacity upon determining that the work cycle includes the travel segment.

6. The energy recovery system of claim 1, further comprising a fourth control valve fluidly disposed between the accumulator and a swing circuit of the machine, wherein the controller is further configured to regulate the fourth control valve to block fluid communication between the accumulator and the swing circuit during the travel segment.

7. The energy recovery system of claim 1, wherein the controller is further configured to:
determine that the work cycle of the machine includes a lowering segment;
determine a parameter indicative of a payload of the implement;
determine a second level capacity of the accumulator based on the determined parameter;
determine if the capacity of the accumulator is less the second level capacity;
control the first control valve to set the capacity of the accumulator at the second level capacity prior to the lowering segment; and
control the second control valve to allow flow of pressurized fluid from the linear actuator to the accumulator during the lowering segment.

8. The energy recovery system of claim 7, wherein the controller is further configured to:
determine a height of the implement relative to a ground surface; and
determine the second level capacity of the accumulator further based on the determined height.

9. The energy recovery system of claim 1, wherein the controller is further configured to:
receive signals indicative of a plurality of operating parameters of the machine;
compare the plurality of operating parameters of the machine with a set of predefined working patterns of the machine; and
determine the work cycle of the machine based on the comparison.

10. The energy recovery system of claim 9, wherein the controller is further configured to:
determine a probability of current operating parameters of the machine matching with a predefined segment of the work cycle; and
control the first control valve based on a speed parameter of the machine if the determined probability is below a threshold.

11. A method of recovering energy in a machine having an implement, the method comprising:
determining that a work cycle of the machine includes a travel segment;
receiving an input indicative of a condition of a terrain traversable by the machine during the travel segment;
determining a first level capacity of an accumulator based on the condition of the terrain, wherein the accumulator is configured to selectively collect pressurized fluid from a linear actuator associated with the implement;
setting the capacity of the accumulator based on the determined first level capacity prior to the travel segment; and
allowing flow of pressurized fluid from the linear actuator to the accumulator during the travel segment.

12. The method of claim 11 further comprising selectively allowing flow of pressurized fluid from the accumulator to a powertrain of the machine during the travel segment.

13. The method of claim 11 further comprising setting the capacity of the accumulator at a default first level capacity upon determining that the work cycle includes the travel segment.

14. The method of claim 11 further comprising blocking fluid communication between the accumulator and a swing circuit of the machine during the travel segment.

15. The method of claim 11 further comprising:
determining that the work cycle of the machine includes a lowering segment;
determining a parameter indicative of a payload of the implement;
determining a second level capacity of the accumulator based on the determined parameter;
determining if the capacity of the accumulator is less than the second level capacity;
setting the capacity of the accumulator at the second level capacity prior to the lowering segment; and
allowing flow of pressurized fluid from the linear actuator to the accumulator during the lowering segment.

16. The method of claim 15 further comprising:
determining a height of the implement relative to a ground surface; and
determining the second level capacity of the accumulator further based on the determined height.

17. A machine comprising:
a frame;
an implement movably coupled to the frame; and
an energy recovery system comprising:
a linear actuator configured to move the implement;
an accumulator configured to selectively collect pressurized fluid from the linear actuator;
a first control valve configured to regulate a capacity of the accumulator;
a second control valve fluidly disposed between the accumulator and the linear actuator, the second control valve configured to regulate a flow of pressurized fluid between the linear actuator and the accumulator; and
a controller disposed in communication with the first control valve and the second control valve, the controller configured to:
determine that a work cycle of the machine includes a travel segment;
receive an input indicative of a condition of a terrain traversable by the machine during the travel segment;
determine a first level capacity of the accumulator based on the condition of the terrain;
control the first control valve to set the capacity of the accumulator based on the determined first level capacity prior to the travel segment; and
control the second control valve to allow flow of pressurized fluid from the linear actuator to the accumulator during both the travel segment and the lowering segment.

18. The machine of claim 17, further comprising a third control valve fluidly disposed between the accumulator and a powertrain of the machine, wherein the third control valve is configured to regulate a flow of pressurized fluid between the accumulator and the powertrain, and wherein the controller is further configured to control the third control valve to selectively allow flow of pressurized fluid from the accumulator to the powertrain during the travel segment.

19. The machine of claim 17, wherein the controller is further configured to:
determine that the work cycle of the machine includes a lowering segment;
determine a parameter indicative of a payload of the implement;
determine a second level capacity of the accumulator based on the determined parameter;
determine if the capacity of the accumulator is less than the second level capacity;
control the first control valve to set the capacity of the accumulator at the second level capacity prior to the lowering segment; and
control the second control valve to allow flow of pressurized fluid from the linear actuator to the accumulator during the lowering segment.

20. The machine of claim 19, wherein the controller is further configured to:
determine a height of the implement relative to a ground surface; and
determine the second level capacity of the accumulator further based on the determined height.
